(19) United States
(12) Patent Application Publication
(10) Pub. No.: US 2017/0213575 A1
(43) Pub. Date: Jul. 27, 2017

(54) APPARATUS AND METHOD FOR CUTTING SEVERAL ENCODED VIDEO STREAMS WITHOUT PRECEDING DECODING

(71) Applicant: Fraunhofer-Gesellschaft zur Foerderung der angewandten Forschung e.V., Munich (DE)

(72) Inventors: Christopher SALOMAN, Stegaurach (DE); Thomas HAUENSTEIN, Nuernberg (DE); Wolfgang THIEME, Schwaig (DE)

(21) Appl. No.: 15/482,254

(22) Filed: Apr. 7, 2017

Related U.S. Application Data
(63) Continuation of application No. PCT/EP2015/073187, filed on Oct. 7, 2015.

(30) Foreign Application Priority Data
Oct. 8, 2014 (DE) 10 2014 220 372.4

(51) Int. Cl. G11B 27/031; H04N 21/438; H04N 21/234

(52) U.S. Cl. CPC G11B 27/031; H04N 21/23424; H04N 21/4384

(57) ABSTRACT

An apparatus for generating a video output data stream by switching from a first video input data stream to a second video input data stream is provided. The apparatus receives encoded video frames of a first video input data stream, each of which is either an encoded intra-frame or an encoded inter-frame. One or several video frames of the first video input data stream are output as one or several encoded video frames of the video output data stream. A switching command instructing to switch to the reception of encoded video frames of the second video input data stream is received, each of the encoded video frames of the second video input data stream being either an encoded intra-frame or an encoded inter-frame. After reception of the switching command, a request command is transmitted requesting the transmission of one of the encoded intra-frames of the second video input data stream. The encoded video frames of the second video input data stream are received and depending on an arrival of one of the intra-frames of the second video input data stream at the interface, this intra-frame and the encoded video frames of the second video input data stream received by the interface after the arrival of this intra-frame as video frames of the video output data stream are output.

### CROSS-REFERENCE TO RELATED APPLICATIONS

This application is a continuation of copending International Application No. PCT/EP2015/073187, filed Oct. 7, 2015, which claims priority from German Application No. 10 2014 220 372.4, filed Oct. 8, 2014, which are each incorporated herein in its entirety by this reference thereto.

The application relates to video processing and in particular to an apparatus and a method for cutting several encoded video streams without preceding decoding.

### BACKGROUND OF THE INVENTION

In a TV production, commonly, video streams are received from several cameras, out of which a mixed output video stream having a cutting sequence still to be defined results, which will then be broadcast. Conventionally, for that purpose, the uncompressed camera video streams are merged on a video switch that can switch the desired picture to the output. New developments in TV production (mobile cameras, very high resolutions, etc.) frequently necessitate preceding compression of the video streams which is normally achieved by using digital video codecs.

In many video codecs, a division of the encoded frames can be performed as follows.

On the one hand, there are pictures that can be calculated back to a displayable frame in an error free manner, independent of other encoded pictures. These are intra-frames. The same can also be referred to as reference pictures.

In picture prediction, an intra-frame (also called intra-picture, I-frame, key picture or reference picture) is a picture within a group of pictures that can be decoded independently (from the other pictures). In a group of pictures, the prediction of the further pictures (that are no intra-frames) is based on the intra-frame. Intra-frames are well known to the person skilled in the art of video signal processing.

On the other hand, there are pictures which refer to other encoded pictures existing in the video stream and which can only be calculated back in an error free manner when the same exist. These are inter-frames. The same can also be referred to as referring pictures (or referring picture).

In inter-frames (also called inter-pictures or referring pictures), part of the picture is indicated by reference to already existing picture data (e.g., of another picture). This reduces the necessitated amount of data. Inter-frames are, for example, P-frames or B-frames. In P-frames, the picture data of the P-frame (among others) are determined from the picture data of preceding pictures. In B-frames, the picture data of the B-frames (among others) are determined from the picture data of preceding and subsequent pictures. Inter-frames, P-frames and B-frames are well-known to the person skilled in the art of video signal processing.

One application example is H264, a video codec where such a division of pictures in intra-frames (reference pictures) and inter-frames (referring pictures) can be performed (regarding H.264, see, for example, [1]).

FIG. 2 shows two exemplary video streams, specifically the structure of H264 streams.

It can be seen that the steam is divided in so-called GOPs (groups of pictures).

In these structures, a reference picture (e.g., in H264: I-frame) is followed by several referring pictures (e.g., in H264: P-frames) which refer to the initial reference picture or other referring pictures. If a GOP structure exists completely, all frames can be decoded from the same in an error free manner.

As described above, conventionally, a video switch is used for cutting which allows the cutting of uncompressed video streams. In order to be able to use this video switch in an environment with video streams that are encoded, these video streams have to be decoded prior to the entry into the switch, which results in a high computing effort which increases the more compressed data streams exist in such a scenario. After that, the same can conventionally be used like uncompressed streams.

Another approach for switching between encoded streams is the usage of so-called S-frames. However, these S-frames can only be used when switching is to be performed between streams that have been generated by the same source, which can then only differ as regards to their quality level (resolution, data rate, etc.).

There are compression standards like JPEG2000 having no intra-frames which has the effect that the same can be cut at any position without special treatment. However, the same necessitate a significantly higher data rate for the same quality.

### SUMMARY

According to an embodiment, an apparatus for generating a video output data stream by switching from a first video input data stream to a second video input data stream may have: an interface for receiving encoded video frames of a first video input data stream, wherein each of the encoded video frames of the first video input data stream is either an encoded intra-frame or an encoded inter-frame, and a video data stream generator for generating the video output data stream, wherein the video data stream generator is configured to output one or several video frames of the first video input data stream as one or several encoded video frames of the video output data stream, wherein the interface is configured to receive a switching command that instructs to switch to the reception of encoded video frames of the second video input data stream, wherein each of the encoded video frames of the second video input data stream is either an encoded intra-frame or an encoded inter-frame, wherein the interface is configured to transmit, after reception of the switching command, a request command that requests the transmission of one of the encoded intra-frames of the second video input data stream, wherein the interface is configured to receive the encoded video frames of the second video input data stream, wherein the video data stream generator is configured to output, depending on an arrival of one of the intra-frames of the second video input data stream at the interface, this intra-frame and the encoded video frames of the second video input data stream received by the interface after the arrival of this intra-frame as video frames of the video output data stream, wherein the video data stream generator is configured to determine this intra-frame of the second video data stream in that the video data stream generator is configured to check, after reception of the switching command, each of the encoded video frames of the second video input data stream arriving at the interface whether this encoded video frame is an encoded intra-frame, wherein the video data stream generator is configured to output this intra-frame as a video frame of the video output data stream, wherein the interface is configured to receive encoded inter-frames of the second video input data stream after the switching command has been received and before the interface has received one of the encoded intra-frames of the second video input data stream after the reception of the switching command, wherein the video data stream generator is configured to output none of the encoded inter-frames of the second video input data stream received by the interface after the switching command has been received and before the interface has received one of the encoded intra-frames of the second video input data stream after reception of the switching command as encoded video frames of the video output data stream, and wherein the video data stream generator is configured to output each of the encoded inter-frames of the second video input data stream received by the interface after the switching command has been received and after the interface has received at least one of the encoded intra-frames of the second video input data stream after reception of the switching command as a video frame of the video output data stream, and wherein the video data stream generator is configured to output each of the encoded video frames of the first video input data stream that are received by the interface after the switching command has been received and before the interface has received one of the encoded intra-frames of the second video input data stream after reception of the switching command as encoded video frame of the video output data stream.

According to another embodiment, a system may have: an inventive apparatus, a first encoder, and a second encoder, wherein the first encoder comprises an encoding unit and an interface, wherein the encoding unit of the first encoder is configured to generate the encoded video frames of the first video input data stream, wherein the interface of the first encoder is configured to transmit the encoded video frames of the first video input data stream to the interface of the inventive apparatus, wherein the second encoder comprises a further encoding unit and a further interface, wherein the encoding unit of the second encoder is configured to generate the encoded video frames of the second video input data stream, wherein the interface of the second encoder is configured to transmit the encoded video frames of the second video input data stream to the interface of the inventive apparatus, wherein the interface of the inventive apparatus is configured to transmit, after reception of the switching command, the request command to the interface of the second encoder, wherein the interface of the second encoder is configured to receive the request command, and wherein the interface of the second encoder is configured to transmit, in response to reception of the request command, one of the encoded video frames of the second video input data stream, which is one of the encoded intra-frames of the second video input data stream, to the interface of the inventive apparatus.

According to another embodiment, a method for generating a video output data stream by switching from a first video input data stream to a second video input data stream may have the steps of: receiving encoded video frames of the first video input data stream, wherein each of the encoded video frames of the first video input data stream is either an encoded intra-frame or an encoded inter-frame, generating the video output data stream, wherein one or several video frames of the first video input data stream are output as one or several encoded video frames of the video output data stream, receiving a switching command that instructs to switch to the reception of encoded video frames of the second video input data stream, wherein each of the encoded video frames of the second video input data stream is either an encoded intra-frame or an encoded inter-frame, after receiving the switching command, transmitting a request command requesting the transmission of one of the encoded intra-frames of the second video input data stream, receiving the encoded video frames of the second video input data stream, and depending on an arrival of one of the intra-frames of the second video input data stream, outputting this intra-frame and the encoded video frames of the second video input data stream received after arrival of this intra-frame as video frames of the video output data stream, wherein this intra-frame of the second video data stream is determined in that, after reception of the switching command, each of the arriving encoded video frames of the second video input data stream is checked for the fact whether this encoded video frame is an encoded intra-frame, wherein this intra-frame is output as a video frame of the video output data stream, wherein encoded inter-frames of the second video input data stream are received after the switching command has been received and before one of the encoded intra-frames of the second video input data stream has been received after the reception of the switching command, wherein none of the encoded inter-frames of the second video input data stream received after the switching command has been received and before one of the encoded intra-frames of the second video input data stream has been received after reception of the switching command are output as encoded video frames of the video output data stream, and wherein each of the encoded inter-frames of the second video input data stream received after the switching command has been received and after at least one of the encoded intra-frames of the second video input data stream has been received after reception of the switching command is output as a video frame of the video output data stream, and wherein each of the encoded video frames of the first video input data stream received after the switching command has been received and before one of the encoded intra-frames of the second video input data stream has been received after reception of the switching command as encoded video frame of the video output data stream.

Another embodiment may have a non-transitory digital storage medium having a computer program stored thereon to perform the method for generating a video output data stream by switching from a first video input data stream to a second video input data stream, the method having the steps of: receiving encoded video frames of the first video input data stream, wherein each of the encoded video frames of the first video input data stream is either an encoded intra-frame or an encoded inter-frame, generating the video output data stream, wherein one or several video frames of the first video input data stream are output as one or several encoded video frames of the video output data stream, receiving a switching command that instructs to switch to the reception of encoded video frames of the second video input data stream, wherein each of the encoded video frames of the second video input data stream is either an encoded intra-frame or an encoded inter-frame, after receiving the switching command, transmitting a request command requesting the transmission of one of the encoded intra-frames of the second video input data stream, receiving the encoded video frames of the second video input data stream, and depending on an arrival of one of the intra-frames of the second video input data stream, outputting this intra-frame and the encoded video frames of the second video input data stream received after arrival of this intra-frame as video frames of the video output data stream, wherein this intra-frame of the second video data stream is determined in that, after reception of the switching command, each of the arriving encoded video frames of the second video input data stream is checked for the fact whether this encoded video frame is an encoded intra-frame, wherein this intra-frame is output as a video frame of the video output data stream, wherein encoded inter-frames of the second video input data stream are received after the switching command has been received and before one of the encoded intra-frames of the second video input data stream has been received after the reception of the switching command, wherein none of the encoded inter-frames of the second video input data stream received after the switching command has been received and before one of the encoded intra-frames of the second video input data stream has been received after reception of the switching command are output as encoded video frames of the video output data stream, and wherein each of the encoded inter-frames of the second video input data stream received after the switching command has been received and after at least one of the encoded intra-frames of the second video input data stream has been received after reception of the switching command is output as a video frame of the video output data stream, and wherein each of the encoded video frames of the first video input data stream received after the switching command has been received and before one of the encoded intra-frames of the second video input data stream has been received after reception of the switching command as encoded video frame of the video output data stream, when said computer program is run by a computer.

An apparatus for generating a video output data stream by switching from a first video input data stream to a second video input data stream is provided. The apparatus includes an interface for receiving encoded video frames of a first video input data stream, wherein each of the encoded video frames of the first video input data stream is either an encoded intra-frame or an encoded inter-frame. Further, the apparatus includes a video data stream generator for generating the video output data stream, wherein the video data stream generator is configured to output one or several video frames of the first video input data stream as one or several encoded video frames of the video output data stream. The interface is configured to receive a switching command that instructs to switch to the reception of encoded video frames of the second video input data stream, wherein each of the encoded video frames of the second video input data stream is either an encoded intra-frame or an encoded inter-frame. Further, the interface is configured to transmit, after reception of the switching command, a request command that requests the transmission of one of the encoded intra-frames of the second video input data stream. Further, the interface is configured to receive the encoded video frames of the second video input data stream. The video data stream generator is configured to output, depending on an arrival of one of the intra-frames of the second video input data stream at the interface, this intra-frame and the encoded video frames of the second video input data stream received by the interface after the arrival of this intra-frame as video frames of the video output data stream.

According to an embodiment, the video data stream generator can be configured, e.g., to determine this intra-frame of the second video data stream in that the video data stream generator is configured to check, after reception of the switching command, each of the encoded video frames of the second video input data stream arriving at the interface whether this encoded video frame is an encoded intra-frame. Here, the video data stream generator can be configured, e.g., to output this intra-frame as a video frame of the video output data stream. Further, the video data stream generator can be configured, e.g., to output none of the encoded inter-frames of the second video input data stream received by the interface after the switching command has been received and before the interface has received one of the encoded intra-frames of the second input data stream after reception of the switching command as encoded video frames of the video output data stream. Further, the video data stream generator can be configured, e.g., to output each of the encoded inter-frames of the second video input data stream received by the interface after the switching command has been received and after the interface has received at least one of the encoded intra-frames of the second video input data stream after reception of the switching command as a video frame of the video output data stream.

In one embodiment, the video data stream generator can be configured, e.g., to output each of the encoded video frames of the first video input data stream that are received by the interface after the switching command has been received and before the interface has received one of the encoded intra-frames of the second video input data stream after reception of the switching command as encoded video frames of the video output data stream.

According to an embodiment, the apparatus can further comprise, e.g., a user interface by means of which a user can trigger the switching command.

In one embodiment, the apparatus can include, e.g., a switching unit that is configured to trigger the switching command, wherein the switching unit can be configured to trigger the switching command independent of a user and wherein the switching unit can further be configured to trigger the switching command independent of the fact when encoded intra-frames of the second video input data stream are received by the interface.

According to an embodiment, the switching command can, e.g., be a first switching command, the request command can, e.g., be a first request command and the interface can, e.g., be configured to receive a second switching command that instructs to switch to the reception of encoded video frames of a third video input data stream, wherein each of the encoded video frames of the third video input data stream is either an encoded intra-frame or an encoded inter-frame. Here, the interface can be configured, e.g., to transmit, after reception of the second switching command, a second request command that requests the transmission of one of the encoded intra-frames of the third video input data stream. Further, the interface can be configured, e.g., to receive the encoded video frames of the third video input data stream. The video data stream generator can be configured, e.g., to check, after reception of the second switching command, each of the encoded video frames of the third video input data stream arriving at the interface, whether this encoded video frame is an encoded intra-frame. The video data stream generator can be configured, e.g., when this encoded video frame is an encoded intra-frame, to output this encoded intra-frame as a video frame of the video output data stream. Further, the video data stream generator can be configured, e.g., to output none of the encoded inter-frames of the third video input data stream received by the interface after the second switching command has been received and before the interface has received one of the encoded intra-frames of the third video input stream after reception of the second switching command as encoded video frames of the video output data stream. Further, the video data stream generator can be configured to output each of the encoded inter-frames of the third video input data stream that is received by the interface after the second switching command has been received and after the interface has received at least one of the encoded intra-frames of the third video input data stream after reception of the second switching command as a video frame of the video output data stream.

Thus, in one embodiment, the interface can be configured, e.g., to receive a group of pictures including one of the encoded intra-frames of the second video input data stream and at least ten of the encoded inter-frames of the second video input data stream, wherein the interface can be configured to receive, at first, the encoded intra-frame of the group of pictures and then the at least ten encoded inter-frames of the group of pictures, wherein the interface can be configured, e.g., to receive no other video frame of the second video input data stream between the encoded intra-frame of the picture sequences and between each of the encoded inter-frames of the second video input data stream. The video data stream generator can be configured, e.g., to output the encoded intra-frame of the picture sequence and each of the at least ten encoded inter-frames of the picture sequence as eleven or several successive encoded video frames of the video output data stream.

In an embodiment, the encoded intra-frame of the second video input data stream is followed by at least thirty intra-frames of the second video input data stream.

Further, a system is provided. The system includes an apparatus as described above, a first encoder and a second encoder. The first encoder comprises an encoding unit and an interface, wherein the encoding unit of the first encoder is configured to generate the encoded video frames of the first video input data stream, wherein the interface of the first encoder is configured to transmit the encoded video frames of the first video input data stream to the interface of the above-described apparatus. The second encoder comprises a further encoding unit and a further interface, wherein the encoding unit of the second encoder is configured to generate the encoded video frames of the second video input data stream, wherein the interface of the second encoder is configured to transmit the encoded video frames of the second video input data stream to the interface of the above-described apparatus. The interface of the above-described apparatus is configured to transmit, after reception of the switching command, the request command to the interface of the second encoder. The interface of the second encoder is configured to receive the request command. Further, the interface of the second encoder is configured to transmit, upon reception of the request command, one of the encoded video frames of the second video input data stream, which is one of the encoded intra-frames of the second video input data stream, to the interface of the above-described apparatus.

According to an embodiment, the interface of the second encoder can be configured, e.g., to transmit, between receiving the request command and transmitting said one of the encoded intra-frames of the second video input data stream, none of the encoded video frames of the second video input data stream, which is no intra-frame, to the interface of the above-described apparatus.

In one embodiment, the interface of the second encoder can be implemented, e.g., to transmit a group of pictures to the interface of the above-described apparatus, wherein the picture sequence includes one of the encoded intra-frames of the second video input data stream and at least ten of the encoded inter-frames of the second video input data stream. The interface of the second encoder can be configured, e.g., to transmit, at first, the encoded intra-frame of the group of pictures and then the at least ten encoded inter-frames of the group of pictures to the interface of the above-described apparatus, wherein the interface of the second encoder can be configured to transmit no other video frame of the second video input data stream between the encoded intra-frame of the picture sequences and between each of the encoded inter-frames of the second video input data stream to the interface of the above-described apparatus. Here, the interface of the above-described apparatus can be implemented, e.g., to receive the group of pictures, wherein the interface of the above-described apparatus can be configured, e.g., to receive, at first, the encoded intra-frame of the group of pictures and then the at least ten encoded inter-frames of the group of pictures, wherein the interface of the above-described apparatus is configured to receive no other video frame of the second video input data stream between the encoded intra-frame of the picture sequences and between each of the encoded inter-frames of the second video input data stream. Here, the video data stream generator of the above-described apparatus can, e.g., be configured to output the encoded intra-frame of the picture sequence and each of the at least ten encoded inter-frames of the picture sequence as eleven or several successive encoded video frames of the video output data stream.

In an embodiment, the encoded intra-frame of the second video input data stream is followed by at least thirty intra-frames of the second video input data stream.

In one embodiment, the system can further comprise one or several terminal devices, wherein each of the one or several terminal devices includes an interface and a decoder. The interface of each of the one or several terminal devices can be configured to receive the video output data stream. Here, the decoder of each of the one or several terminal devices can be configured to decode the encoded video frames of the video output data stream.

Further, a method for generating a video output data stream by switching from a first video input data stream to a second video input data stream is provided. The method comprises:
receiving encoded video frames of the first video input data stream, wherein each of the encoded video frames of the first video input data stream is either an encoded intra-frame or an encoded inter-frame.
generating the video output data stream, wherein one or several video frames of the first video input data stream are output as one or several encoded video frames of the video output data stream.
receiving a switching command that instructs to switch to the reception of encoded video frames of the second video input data stream, wherein each of the encoded video frames of the second video input data stream is either an encoded intra-frame or an encoded inter-frame.
after receiving the switching command, transmitting a request command requesting the transmission of one of the encoded intra-frames of the second video input data stream.
receiving the encoded video frames of the second video input data stream. And:
depending on an arrival of one of the intra-frames of the second video input data stream, outputting this intra-frame and the encoded video frames of the second video input data stream received after arrival of this intra-frame as video frames of the video output data stream.

Further, a computer program having a program code for performing the above-described method is provided.

Concepts of embodiments are based on making the GOP structure as large as possible, i.e., to use as few reference pictures as possible. This results in a lower data rate with constant quality of the video.

Embodiments realize that despite the specific structure of such video codecs, mixing of such encoded video streams is possible.

With the provided concepts, it becomes possible to effectively cut several encoded video streams even with large GOP structures (structures of groups of pictures) without necessitating decoding of these streams. As described above, correct decoding of referring pictures is only possible when the associated reference picture (reference frame) and all allocated other referring pictures exist.

Thus, if switching between the two video streams is to be performed, it is not possible to insert the next frame into the output video stream (the target video stream) without any measures, since otherwise possibly referring pictures would be inserted of which the necessitated other frames (in particular, e.g., a necessitated referring picture) do not exist. Such a procedure would result in artifacts in the output video.

Embodiments are based on the concept of executing the command for switching not directly but, according to an embodiment, the apparatus rather considers the command merely as a request to fulfill this command at the next possible time. However, in large (structures of groups of pictures) GOP structures, this would have the effect that the switching process would only be executed in a significantly delayed manner. Embodiments solve this problem by transmitting a request command that requests an intra-frame of the data stream that is to be switched to.

In the following, embodiments of the invention will be described with reference to the drawings.

### BRIEF DESCRIPTION OF THE DRAWINGS

Embodiments of the present invention will be detailed subsequently referring to the appended drawings, in which:

FIG. 1 shows an apparatus according to an embodiment,

FIG. 2 shows two exemplary video streams, specifically, the structure of H264 streams,

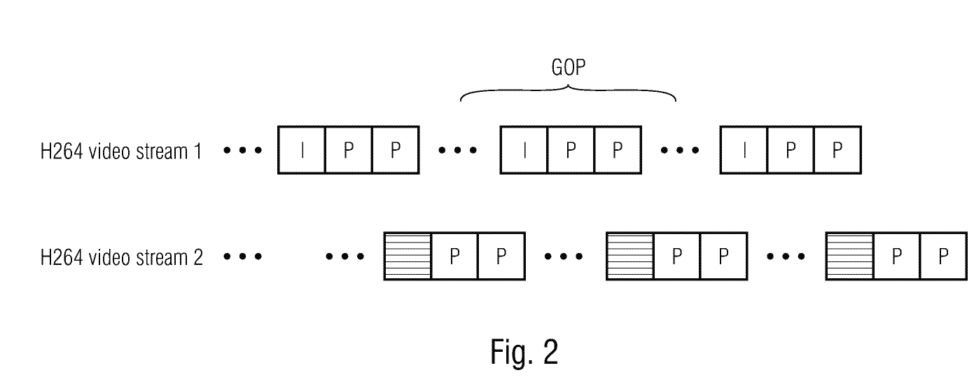

FIG. 3 shows an apparatus according to a further embodiment further comprising a user interface,

FIG. 4 shows an apparatus according to a further embodiment further comprising a switching unit,

FIG. 5 shows an apparatus according to a further embodiment having three video input data streams,

FIG. 6 shows a system according to an embodiment including an apparatus according to an embodiment and two encoders,

FIG. 7 shows a system according to an embodiment further including two terminal devices, and

FIG. 8 shows a direct request of an intra-frame at an encoder in a system according to an embodiment.

### DETAILED DESCRIPTION OF THE INVENTION

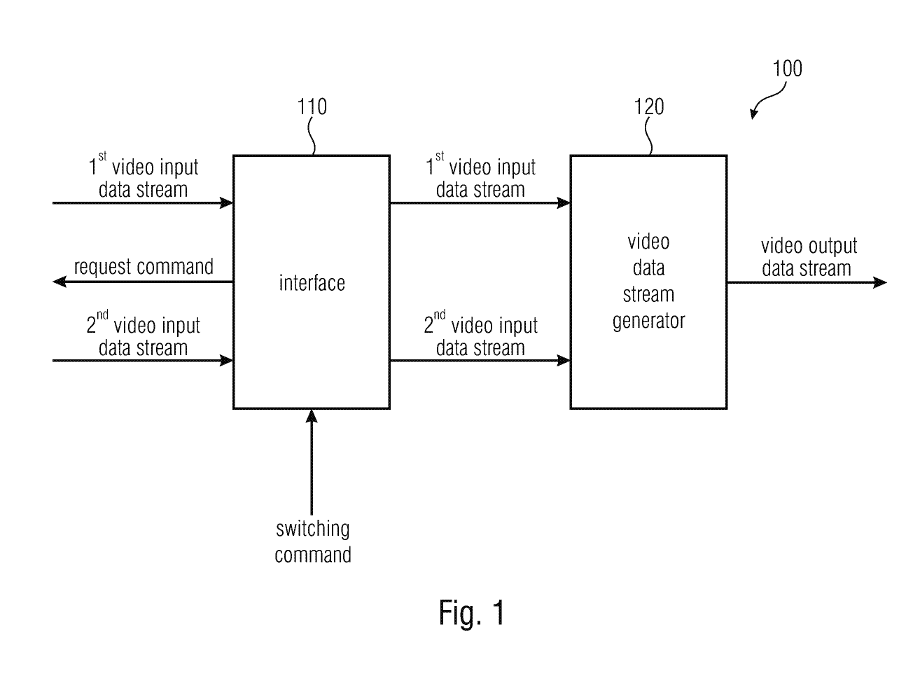

FIG. 1 shows an apparatus 100 for generating a video output data stream by switching from a first video input data stream to a second video input data stream according to an embodiment.

The apparatus 100 includes an interface 110 for receiving encoded video frames of a first video input data stream, wherein each of the encoded video frames of the first video input data stream is either an encoded intra-frame or an encoded inter-frame.

Further, the apparatus 100 includes a video data stream generator 120 for generating the video output data stream, wherein the video data stream generator 120 is configured to output one or several video frames of the first video input data stream as one or several encoded video frames of the video output data stream.

The interface 110 is configured to receive a switching command that instructs to switch to the reception of encoded video frames of the second video input data stream. Here, each of the encoded video frames of the second video input data stream is here again either an encoded intra-frame or an encoded inter-frame.

Now, the interface 110 is configured to transmit, after reception of the switching command, a request command requesting the transmission of one of the encoded intra-frames of the second video input data stream.

Further, the interface 110 is configured to receive the encoded video frames of the second video input data stream. Here, the video data stream generator 120 is configured to output, depending on an arrival of one of the intra-frames of the second video input data stream at the interface 110, this intra-frame and the encoded video frames of the second video input data stream received by the interface after the arrival of this intra-frame as video frames of the video output data stream.

Embodiments of the invention relate, e.g., to the assembly of a video output data stream as a live stream, wherein, from several camera live recordings, at first, the (first) video input data stream of a first camera, then, in response to the switching command, the (second) video input data stream of a second camera is to be inserted in the video output data stream.

Here, it is a problem that the video input data streams only occasionally comprise intra-frames that can be decoded separately, but also a plurality of successive inter-frames necessitating an intra-frame for decoding the same.

If the switching command arrives when inter-frames of the second video input data stream are received by the interface 110, immediate switching has the effect that, at first, the frames of the first video input data stream in the video output data stream are followed by inter-frames of the second video input data stream in the video output data stream that cannot be decoded separately, e.g. by a receiving decoder of a recipient of the video output data stream, without the matching intra-frame of the second video input data stream. Consequently, when switching immediately, artifacts result in decoding.

If, however, switching is delayed until an intra-frame of the second video data stream arrives at the interface 110, this can result in undesirable time delays, in particular when the groups of pictures of the second video input data stream each consist of an intra-frame and a large number of inter-frames (when, e.g. 10 inter-frames follow one intra-frame or, e.g. in particular when 30 inter-frames follow one intra-frame). This applies in particular when it takes particularly long in the second input data stream until the next intra-frame is transmitted again.

A third option of preventively storing possibly necessitated intra-frames of the second video data stream, even before a switching command is issued, results in increased storage requirements and increased necessitated processor time for storing the preventively stored frames, which is undesirable.

The present invention solves these technical problems in that the interface 110 is configured to transmit, after reception of a switching command, a request command that requests the transmission of one of the encoded intra-frames of the second video input data stream. By this explicit request command of an intra-frame, an encoder providing the second video data stream can be informed that an intra-frame is necessitated. The encoder is informed by the request command of the interface 110 about the desire of the apparatus 100 to immediately receive an intra-frame and can transmit the same to the interface 110.

One of the advantages resulting from this is that the apparatus 100 can also receive groups of pictures with a large number of inter-frames and fast switching still remains possible. Not very many intra-frames have to be preventively provided in the video input data streams in order to allow fast switching at any time. Instead, a necessitated intra-frame is explicitly requested by the request command when the switching command is issued.

This also has the effect that it is not necessitated to recode the video input data streams in the apparatus 100 (from input data streams having relatively many intra-frames for allowing fast switching recoded to an output data stream having relatively few intra-frames for keeping the data rate low) when the output data stream is to include only relatively few intra-frames. Instead, the frames of the respectively selected video input data stream can be output directly as frames of the video output data stream as soon as the requested intra-frame arrives at the interface 110.

Acceleration of obtaining the intra-frame of the second data stream is achieved by the request command. However, there is still a low time delay or small time delay between the arrival of the switching command and the arrival of the first intra-frame from the second video input data stream, since the transmission of the request command to the encoder of the second video input data stream will necessitate time, even only little. In the meantime, inter-frames of the second data stream can arrive at the interface 110 which may then, however, not enter the video output data stream according to an embodiment.

According to an embodiment, the video data stream generator 120 can be configured, e.g., to determine arrival of the first inter-frame of the second video data stream in that the video data stream generator 120 is configured to check, after reception of the switching command, each of the encoded video frames of the second video input data stream arriving at the interface 110 whether this encoded video frame is an encoded intra-frame. Then, the video data stream generator 120 can be configured to output this intra-frame as a video frame of the video output data stream.

Further, the video data stream generator can be configured, e.g., to output none of the encoded inter-frames of the second video input data stream received by the interface after the switching command has been received and before the interface has received one of the encoded intra-frames of the second video input data stream after reception of the switching command as encoded video frames of the video output data stream. These inter-frames of the second video input data stream cannot be decoded without an intra-frame of the second video input data stream. If the same were still inserted in the video output data stream, this would result in artifacts at a decoder receiving the video output data stream and wanting to decode the same, which is to be avoided.

Further, the video data stream generator 120 can be configured to output each of the encoded inter-frames of the second video input data stream received by the interface 110 after the switching command has been received and after the interface 110 has received at least one of the encoded intra-frames of the second video input data stream after reception of the switching command as a video frame of the video output data stream. These inter-frames of the second video input data stream can then be decoded without artifacts by a decoder receiving and decoding the video output data stream, since already the preceding intra-frame of the second video input data stream has been inserted in the video output data stream.

In one embodiment, the video data stream generator can be configured, e.g., to output each of the encoded video frames of the first video input data stream received by the interface after the switching command has been received and before the interface has received one of the encoded intra-frames of the second video input data stream after receipt of the switching command as encoded video frames of the video output data stream. In order that no temporal breaks occur in the video output data stream, it can be useful, for the short transition period up to the arrival of the requested first intra-frame of the second video input data stream, to keep inserting the frames of the first video input data stream into the video output data stream since the same can each be decoded.

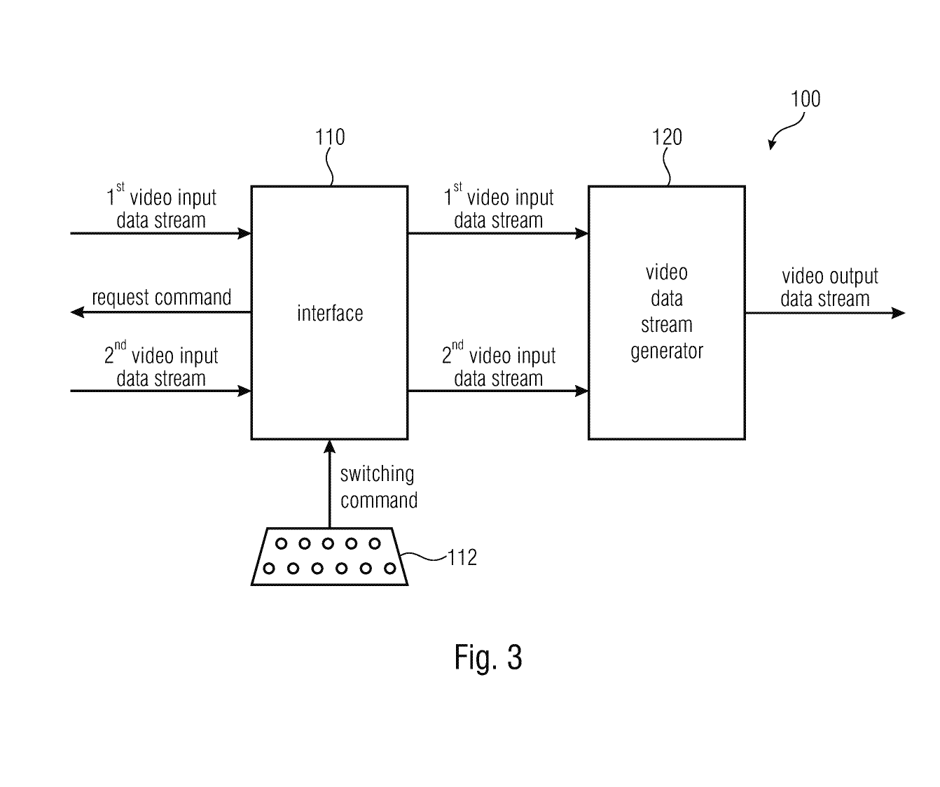

According to an embodiment, the apparatus 100 can further comprise, e.g., a user interface 112, by means of which a user can trigger the switching command. FIG. 3 shows such a user interface 112, where, e.g., a live broadcast producer can trigger switching, e.g. from camera picture 1 to camera picture 2. The user interface can, e.g., be a keyboard or buttons of a mixing desk for mixing video streams.

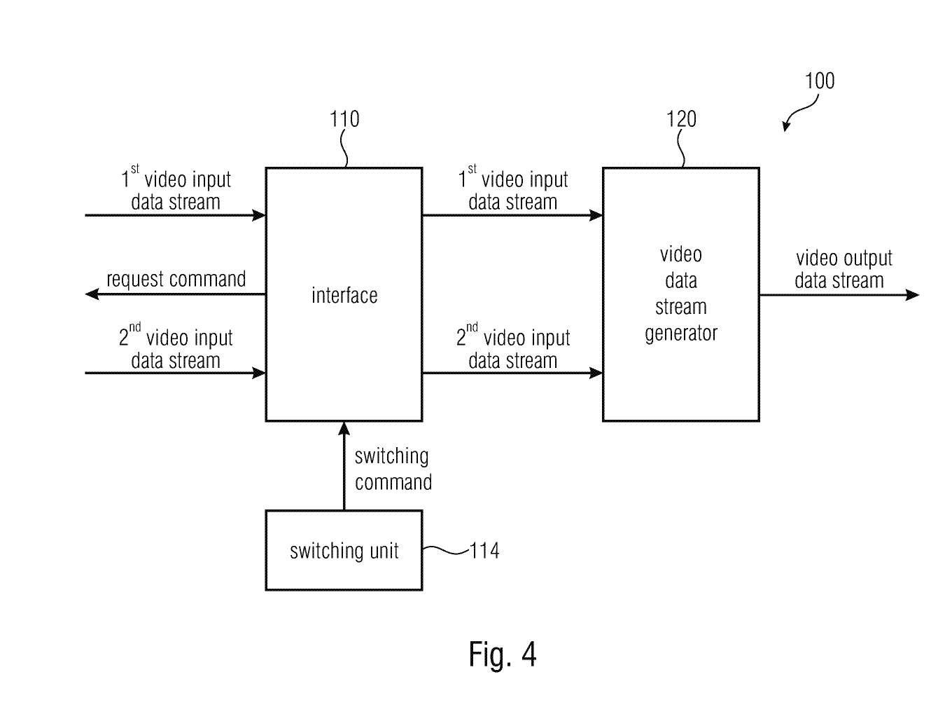

In one embodiment, shown in FIG. 4, the apparatus 100 can further comprise a switching unit 114 that is configured to trigger the switching command 114, wherein the switching unit 114 can be configured to trigger the switching command independent of a user, and wherein the switching unit 114 can further be configured to trigger the switching command independent of when encoded intra-frames of the second video input data stream are received by the interface 110. The switching unit 114 can, e.g., be a time switch, allowing switching between monitoring videos from different monitoring cameras in fixed or variable time intervals. Coordinating switching in the program logic of the switching unit in response to the arrival of I-frames would be technically expensive. Constant artifacts in the video output data stream providing the monitoring video presented to the user are nevertheless undesirable.

In particular in embodiments where switching is performed between three or more video streams, the advantages of the above presented concepts are particularly advantageous. During frequent switching between the video input data streams, as it is particularly the case with a large number of video input data streams, without the usage of the inventive apparatus 100, time delays would occur to a great extent.

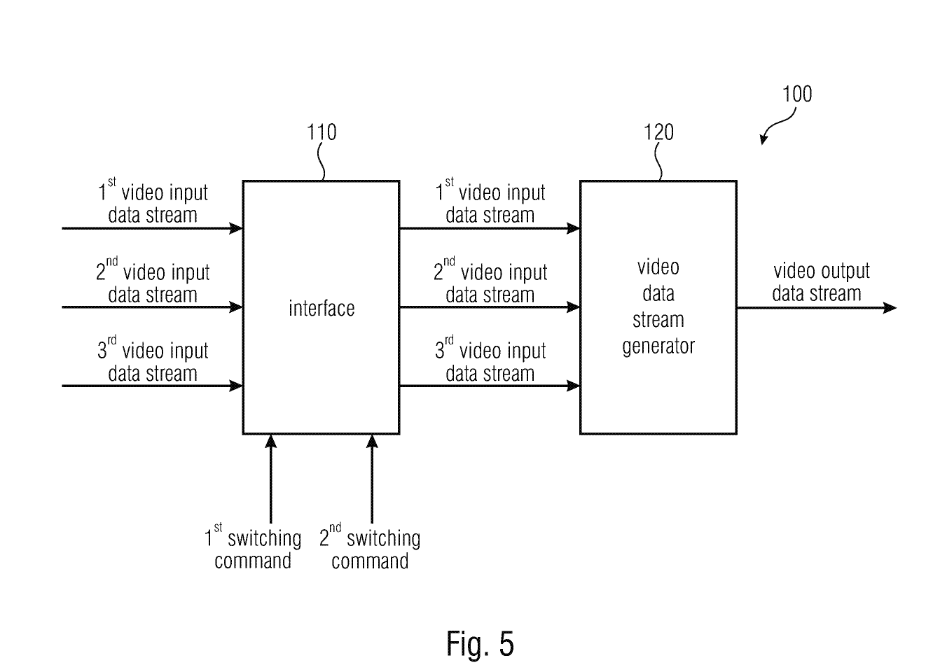

Thus, FIG. 5 shows an embodiment where the above-stated switching command is a first switching command and the above-stated request command is a first request command. The interface can be configured, e.g., to receive a second switching command that instructs to switch to the reception of encoded video frames of a third video input data stream, wherein each of the encoded video frames of the third video input data stream is either an encoded intra-frame or an encoded inter-frame. Here, the interface can be configured, e.g., to transmit, after reception of the second switching command, a further request command that requests the transmission of one of the encoded intra-frames of the third video input data stream. Further, the interface can be configured, e.g., to receive the encoded video frames of the third video input data stream. The video data stream generator can be configured, e.g., to check, after reception of the switching command, each of the encoded video frames of the third video input data stream arriving at the interface whether this encoded video frame is an encoded intra-frame. The video data stream generator can be configured, e.g., when this encoded video frame is an encoded intra-frame, to output this encoded intra-frame as a video frame of the video output data stream. Further, the video data stream generator can be configured, e.g., to output none of the encoded inter-frames of the third video input data stream received by the interface after the second switching command has been received and before the interface has received one of the encoded intra-frames of the third video input data stream after reception of the second switching command as encoded video frames of the video output data stream. Further, the video data stream generator can be configured to output each of the encoded inter-frames of the third video input data stream received by the interface after the second switching command has been received and after the interface has received at least one of the encoded intra-frames of the third video input data stream after reception of the second switching command as a video frame of the video output data stream.

The above stated concepts are particularly advantageous when, as has already been mentioned, a large number of inter-frames follow an intra-frame in the video input data stream.

Thus, in one embodiment, the interface can be configured, e.g., to receive a group of pictures including one of the encoded intra-frames of the second video input data stream and at least ten of the encoded inter-frames of the second video input data stream, wherein the interface can be configured to receive, at first, the encoded intra-frame of the group of pictures and then the at least ten encoded inter-frames of the group of pictures, wherein the interface can be configured, e.g., to receive no other video frame of the second video input data stream between the encoded intra-frame of the picture sequences and between each of the encoded inter-frames of the second video input data stream. The video data stream generator can be configured, e.g., to output the encoded intra-frame of the picture sequence and each of the at least ten encoded inter-frames of the picture sequence as eleven or several successive encoded video frames of the video output data stream.

In an embodiment, at least 30 intra-frames of the second video input data stream follow the encoded intra-frame of the second video input data stream.

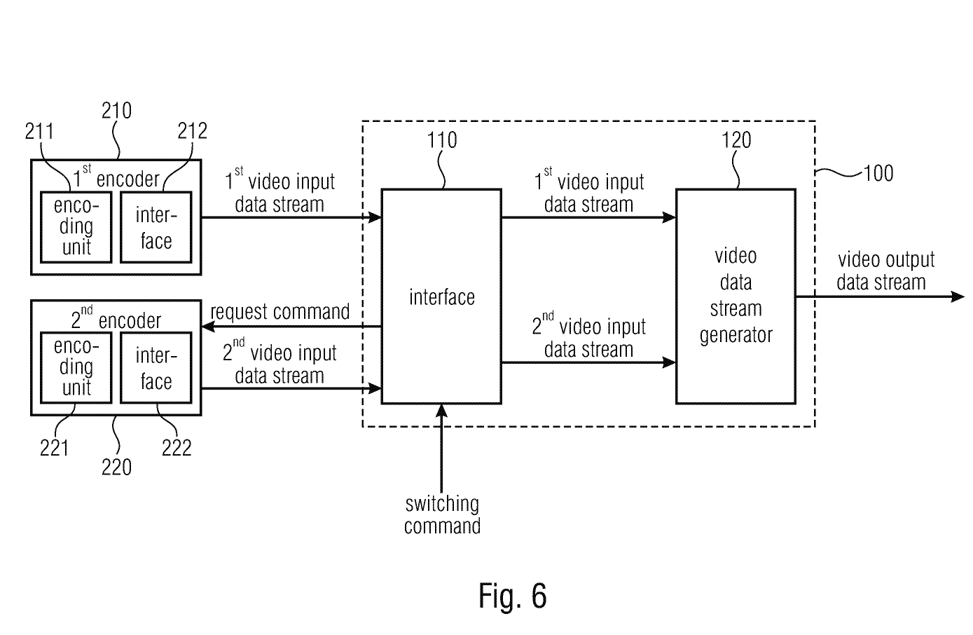

FIG. 6 shows a system according to an embodiment. The system includes the above-described apparatus 100, a first encoder 210 and a second encoder 220.

The first encoder 210 comprises an encoding unit 211 and an interface 212, wherein the encoding unit 211 of the first encoder 210 is configured to generate the encoded video frames of the first video input data stream and wherein the interface 212 of the first encoder is configured to transmit the encoded video frames of the first video input data stream to the interface 110 of the above-described apparatus 100.

The second encoder 220 comprises a further encoding unit 221 and a further interface 222, wherein the encoding unit 221 of the second encoder 220 is configured to generate the encoded video frames of the second video input data stream and wherein the interface 222 of the second encoder 220 is configured to transmit the encoded video frames of the second video input data stream to the interface 110 of the above-described apparatus 100.

The interface 110 of the above-described apparatus 100 is configured to transmit, after reception of the switching command, the request command to the interface 222 of the second encoder 220. The interface 222 of the second encoder 220 is configured to receive the request command. Further, the interface 222 of the second encoder 220 is configured to transmit, upon reception of the request command, one of the encoded video frames of the second video input data stream, which is one of the encoded intra-frames of the second video input data stream, to the interface 110 of the above-described apparatus 100.

According to an embodiment, the interface 222 of the second encoder 220 can be configured, e.g., to transmit, between receiving the request command and transmitting said one of the encoded intra-frames of the second video input data stream, none of the encoded video frames of the second video input data stream, which is no intra-frame, to the interface of the above-described apparatus 100.

In one embodiment, the interface 222 of the second encoder 220 can be configured, e.g., to transmit a group of pictures to the interface 110 of the above-described apparatus 100, wherein the picture sequence includes one of the encoded intra-frames of the second video input data stream and at least ten of the encoded inter-frames of the second video input data stream. Here, the interface 222 of the second encoder 220 can be configured, e.g., to transmit, at first, the encoded intra-frame of the group of pictures and then the at least ten encoded inter-frames of the group of pictures to the interface of the above-described apparatus 100. Here, the interface of the second encoder is configured to transmit no other video frame of the second video input data stream between the encoded intra-frame of the picture sequences and between each of the encoded inter-frames of the second video input data stream to the interface of the above-described apparatus 100.

Here, the interface 110 of the above-described apparatus 100 is configured to receive the group of pictures, wherein the interface 110 of the apparatus 100 is configured, e.g., to receive, at first, the encoded intra-frame of the group of pictures and then the at least ten encoded inter-frames of the group of pictures, wherein the interface 110 of the above-described apparatus 100 is configured to receive no other video frame of the second video input data stream between the encoded intra-frame of the picture sequences and between each of the encoded inter-frames of the second video input data stream. The video data stream generator 120 of the above-described apparatus 100 can be configured, e.g., to output the encoded intra-frame of the picture sequence and each of the at least ten encoded inter-frames of the picture sequence as eleven or several successive encoded video frames of the video output data stream.

In one embodiment, the encoded intra-frame of the second video input data stream is followed by at least 30 intra-frames of the second video input data stream.

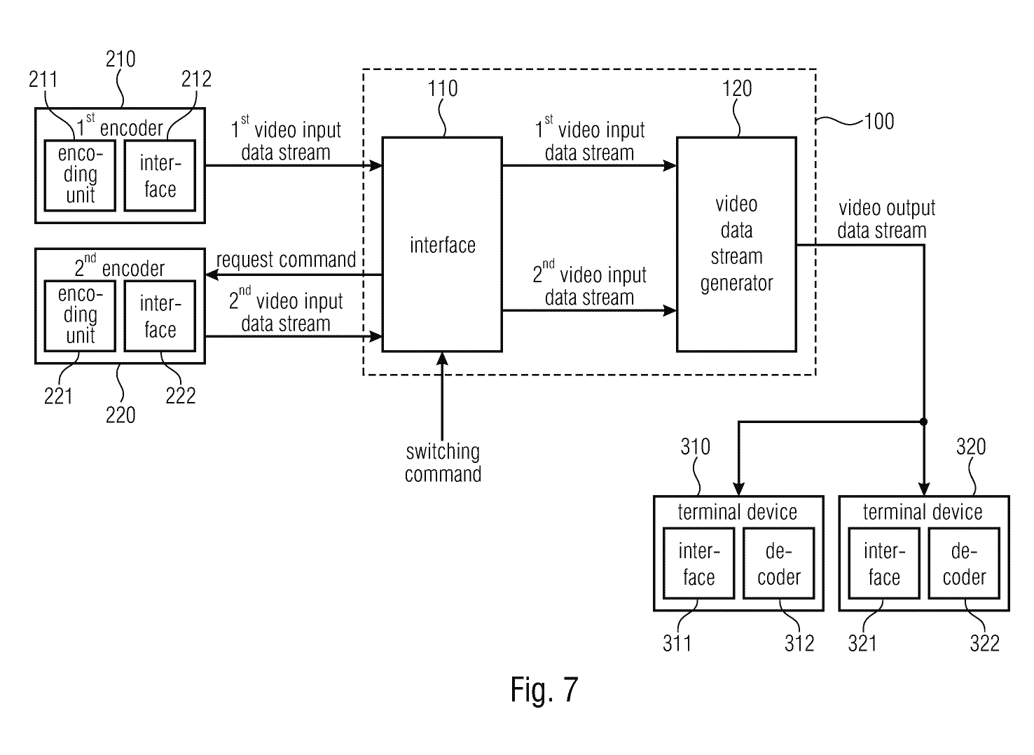

FIG. 7 shows an embodiment where the system further comprises one or several terminal devices (in FIG. 7 two terminal device 310, 320), wherein each of the one or several terminal devices includes an interface 311, 321 and a decoder 321, 322. The interface 311, 321 of each of the one or several terminal devices 310, 320 can be configured to receive the video output data stream. Here, the decoder 312, 322 of each of the one or several terminal devices 310, 320 can be configured to decode the encoded video frames of the video output data stream.

The system comprises, e.g., to or more terminal devices 310, 320.

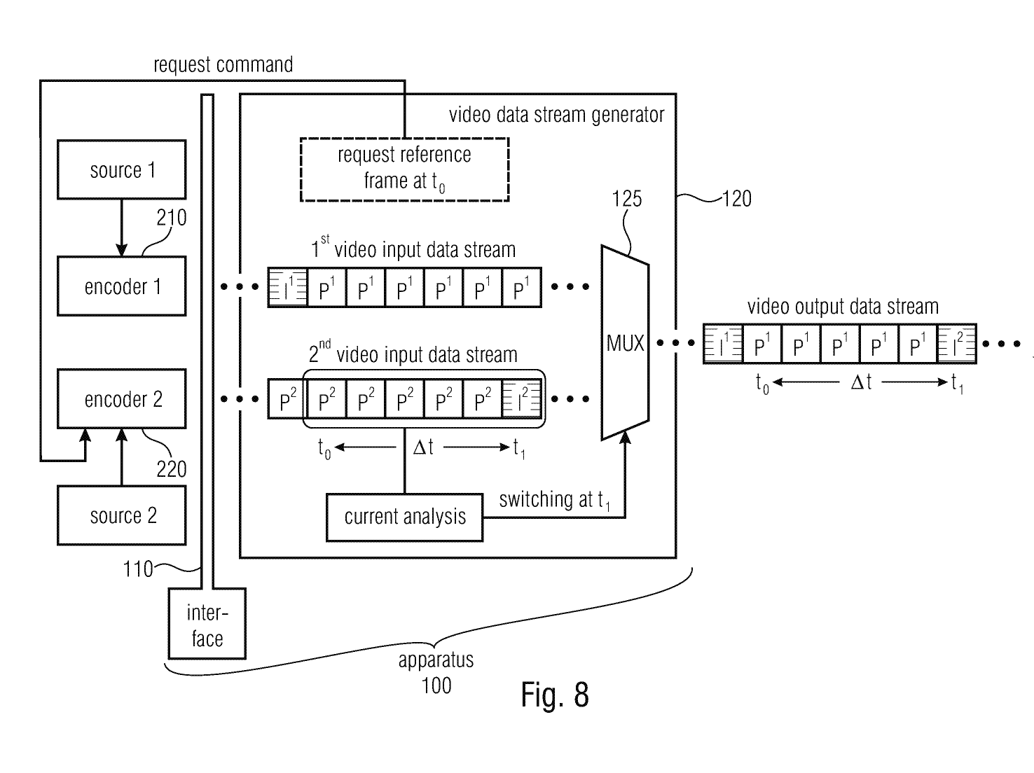

FIG. 8 shows a system according to a further embodiment. Specifically, a direct request of an intra-frame (reference frame) in an encoder according to an embodiment is shown. The video stream generator 120 of the above-described apparatus 100 includes a multiplexer 125 for generating the video output data stream by multiplexing the first video input data stream and the second video input data stream. In the video data stream, I stands for an intra-frame, P stands for an inter-frame (e.g. a P-frame), index 1 designates the first video input data stream and index 2 designates the second video input data stream.

In a specific embodiment, as shown in FIG. 8, the following exemplary sequence is realized:
1. A command for switching to stream 2 is received (time: t₀).
2. The system registers this command, requests a new reference frame from the respective encoder 220 and starts analyzing the stream to which switching is to be performed.
3. A reference picture is detected on the same, it is possible to switch the stream without artifacts (time: t₁). The stream analysis is no longer necessitated and is terminated.
4. The old stream is disconnected from the output and provides no more packets to the same.
5. The reference picture from stream 2 and all subsequent P frames of the same are connected to the output.
6. The switching process is now completed.

Thus, control for an encoder 220 is realized that can indicate to the encoder 220 from outside that a new intra-frame (reference picture) is to be generated when a switching command has been registered.

With the provided apparatus 100 it is possible to still use large GOP structures at low Δt. Thereby, the data rate can be lowered with constant video quality and it is still possible to quickly switch the stream.

With a given maximum data rate of a channel, this has the advantage, e.g., that more cameras in the system can use the channel with constant quality.

Further, stronger error protection mechanisms can be implemented since more data rate “is left” available for the same. Thereby, interference resistance or, e.g., in wireless transmissions, the range can be increased.

Further, the quality of the camera streams can be increased since the same can consume higher data rates.

Additionally, in conventional systems it is frequently necessitated to compress the cut signal at the output of the switch for further transmission (via satellite, Internet, etc.) whereby it becomes necessitated to decode the received signal from the camera, to cut the same in the video switch and encode it again thereafter. The unnecessary steps of encoding (recording device), then decoding (video switch) and then encoding (video switch at the output) are no longer necessitated. Instead, encoding has to be performed only on the side of the recording device.

This has the advantage of low latency time: Decoding and renewed encoding needs time which results in a delay of the output stream relative to the recording time.

Further, less energy consumption is needed. The decoding and encoding processes consume current which results in reduced battery runtime in mobile systems.

Further, there are less requirements as regards to computing power: the decoding and encoding processes place high demand on the computing power of the cutting device. Thereby, the old approach can only be performed on mobile devices to a limited extent and necessitates more expensive hardware in stationary devices.

Further, better scalability is obtained: No unused decoder stages have to be provided for the inputs of the video switch.

Embodiments can be used in any setup where several encoded streams are to be cut or switched: TV production, streaming services, live cut, broadcast van, mobile media coverage, monitoring cameras, etc.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be executed by a hardware apparatus (or by using a hardware apparatus), like, for example, a microprocessor, a programmable computer or an electronic circuit. In some embodiments, some or several of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may for example be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive methods is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transmit a computer program for performing one of the methods described herein to a receiver. The transmission can be performed electronically or optically. The receiver may, for example, be a computer, a mobile device, a memory device or the like. The apparatus or system may, for example, comprise a file server for transferring the computer program to the receiver.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The above described embodiments are merely illustrative for the principles of the present invention. It is understood that modifications and variations of the arrangements and the details described herein will be apparent to others skilled in the art. It is the intent, therefore, that the invention is limited only by the scope of the appended patent claims and not by the specific details presented by way of description and explanation of the embodiments herein.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] The H.264 Advanced Video Compression Standard Second Edition, Wley, ISBN: 978-0-470-51692-8 EFFICIENT VIDEO STREAM SWITCHING WITH PROGRESSIVE S-FRAMES, Byeong-Doo Choi, Ju-Hun Nam, Jin-Hyung Kim, Sung-Hoon Yun, and Sung-Jea Ko, Sen:wqior Member, IEEE.

1. Apparatus for generating a video output data stream by switching from a first video input data stream to a second video input data stream, comprising:
an interface for receiving encoded video frames of a first video input data stream, wherein each of the encoded video frames of the first video input data stream is either an encoded intra-frame or an encoded inter-frame, and
a video data stream generator for generating the video output data stream, wherein the video data stream generator is configured to output one or several video frames of the first video input data stream as one or several encoded video frames of the video output data stream,
wherein the interface is configured to receive a switching command that instructs to switch to the reception of encoded video frames of the second video input data stream, wherein each of the encoded video frames of the second video input data stream is either an encoded intra-frame or an encoded inter-frame,
wherein the interface is configured to transmit, after reception of the switching command, a request command that requests the transmission of one of the encoded intra-frames of the second video input data stream,
wherein the interface is configured to receive the encoded video frames of the second video input data stream,
wherein the video data stream generator is configured to output, depending on an arrival of one of the intra-frames of the second video input data stream at the interface, this intra-frame and the encoded video frames of the second video input data stream received by the interface after the arrival of this intra-frame as video frames of the video output data stream,
wherein the video data stream generator is configured to determine this intra-frame of the second video data stream in that the video data stream generator is configured to check, after reception of the switching command, each of the encoded video frames of the second video input data stream arriving at the interface whether this encoded video frame is an encoded intra-frame,
wherein the video data stream generator is configured to output this intra-frame as a video frame of the video output data stream,
wherein the interface is configured to receive encoded inter-frames of the second video input data stream after the switching command has been received and before the interface has received one of the encoded intra-frames of the second video input data stream after the reception of the switching command,
wherein the video data stream generator is configured to output none of the encoded inter-frames of the second video input data stream received by the interface after the switching command has been received and before the interface has received one of the encoded intra-frames of the second video input data stream after reception of the switching command as encoded video frames of the video output data stream, and
wherein the video data stream generator is configured to output each of the encoded inter-frames of the second video input data stream received by the interface after the switching command has been received and after the interface has received at least one of the encoded intra-frames of the second video input data stream after reception of the switching command as a video frame of the video output data stream, and
wherein the video data stream generator is configured to output each of the encoded video frames of the first video input data stream that are received by the interface after the switching command has been received and before the interface has received one of the encoded intra-frames of the second video input data stream after reception of the switching command as encoded video frame of the video output data stream.

2. Apparatus according to claim 1, wherein the apparatus further comprises a user interface by means of which a user can trigger the switching command.

3. Apparatus according to claim 1,
wherein the apparatus further comprises a switching unit that is configured to trigger the switching command,
wherein the switching unit is configured to trigger the switching command independent of a user, and
wherein the switching unit is configured to trigger the switching command independent of the fact when encoded intra-frames of the second video input data stream are received by the interface.

4. Apparatus according to claim 1,
wherein the switching command is the first switching command,
wherein the request command is a first request command,
wherein the interface is configured to receive a second switching command that instructs to switch to the reception of encoded video frames of a third video input data stream, wherein each of the encoded video frames of the third video input data stream is either an encoded intra-frame or an encoded inter-frame,
wherein the interface is configured to transmit, after reception of the second switching command, a second request command that requests the transmission of one of the encoded intra-frames of the third video input data stream,
wherein the interface is configured to receive the encoded video frames of the third video input data stream,
wherein the video data stream generator is configured to check, after reception of the second switching command, each of the encoded video frames of the third video input data stream arriving at the interface, whether this encoded video frame is an encoded intra-frame and wherein the video data stream generator is configured, when this encoded video frame is an encoded intra-frame, to output this encoded intra-frame as a video frame of the video output data stream,
wherein the video data stream generator is configured to output none of the encoded inter-frames of the third video input data stream received by the interface after the second switching command has been received and before the interface has received one of the encoded intra-frames of the third video input data stream after reception of the second switching command as encoded video frames of the video output data stream, and
wherein the video data stream generator is configured to output each of the encoded inter-frames of the third video input data stream that is received by the interface after the second switching command has been received and after the interface has received at least one of the encoded intra-frames of the third video input data stream after reception of the second switching command as a video frame of the video output data stream.

5. Apparatus according to claim 1,
wherein the interface is configured to receive a group of pictures comprising one of the encoded intra-frames of the second video input data stream and at least ten of the encoded inter-frames of the second video input data stream, wherein the interface is configured to receive, at first, the encoded intra-frame of the group of pictures and then the at least ten encoded inter-frames of the group of pictures, wherein the interface is configured to receive no other video frame of the second video input data stream between the encoded intra-frame of the picture sequences and between each of the encoded inter-frames of the second video input data stream, and
wherein the video data stream generator is configured to output the encoded intra-frame of the picture sequence and each of the at least ten encoded inter-frames of the picture sequence as eleven or several successive encoded video frames of the video output data stream.

6. Apparatus according to claim 1,
wherein the interface is configured to receive a group of pictures comprising one of the encoded intra-frames of the second video input data stream and at least 30 of the encoded inter-frames of the second video input data stream, wherein the interface is configured to receive, at first, the encoded intra-frame of the group of pictures and then the at least 30 encoded inter-frames of the group of pictures, wherein the interface is configured to receive no other video frame of the second video input data stream between the encoded intra-frame of the picture sequences and between each of the encoded inter-frames of the second video input data stream, and
wherein the video data stream generator is configured to output the encoded intra-frame of the picture sequence and each of the at least 30 encoded inter-frames of the picture sequence as 31 or several successive encoded video frames of the video output data stream.

7. A system comprising,
an apparatus according to claim 1,
a first encoder, and
a second encoder,
wherein the first encoder comprises an encoding unit and an interface, wherein the encoding unit of the first encoder is configured to generate the encoded video frames of the first video input data stream, wherein the interface of the first encoder is configured to transmit the encoded video frames of the first video input data stream to the interface of the apparatus according to claim 1,
wherein the second encoder comprises a further encoding unit and a further interface, wherein the encoding unit of the second encoder is configured to generate the encoded video frames of the second video input data stream, wherein the interface of the second encoder is configured to transmit the encoded video frames of the second video input data stream to the interface of the apparatus according to claim 1,
wherein the interface of the apparatus according to claim 1 is configured to transmit, after reception of the switching command, the request command to the interface of the second encoder,
wherein the interface of the second encoder is configured to receive the request command, and
wherein the interface of the second encoder is configured to transmit, in response to reception of the request command, one of the encoded video frames of the second video input data stream, which is one of the encoded intra-frames of the second video input data stream, to the interface of the apparatus according to claim 1.

8. System according to claim 7, wherein the interface of the second encoder is configured to transmit, between receiving the request command and transmitting said one of the encoded intra-frames of the second video input data stream, none of the encoded video frames of the second video input data stream, which is no intra-frame, to the interface of the apparatus according to claim 1.

9. System according to claim 7,
wherein the interface of the second encoder is configured to transmit a group of pictures to the interface of the apparatus according to claim 1, wherein the picture sequence comprises one of the encoded intra-frames of the second video input data stream and at least ten of the encoded inter-frames of the second video input data stream, wherein the interface of the second encoder is configured to transmit, at first, the encoded intra-frame of the group of pictures and then the at least ten encoded inter-frames of the group of pictures to the interface of the apparatus according to claim 1, wherein the interface of the second encoder is configured to transmit no other video frame of the second video input data stream between the encoded intra-frame of the picture sequences and between each of the encoded inter-frames of the second video input data stream to the interface of the apparatus according to claim 1,
wherein the interface of the apparatus according to claim 1 is configured to receive the group of pictures, wherein the interface of the apparatus according to claim 1 is configured to receive, at first, the encoded intra-frame of the group of pictures and then the at least ten encoded inter-frames of the group of pictures, wherein the interface of the apparatus according to claim 1 is configured to receive no other video frame of the second video input data stream between the encoded intra-frame of the picture sequences and between each of the encoded inter-frames of the second video input data stream, and
wherein the video data stream generator of the apparatus according to claim 1 is configured to output the encoded intra-frame of the picture sequence and each of the at least ten encoded inter-frames of the picture sequence as eleven or several successive encoded video frames of the video output data stream.

10. System according to claim 7,
wherein the interface of the second encoder is configured to transmit a group of pictures to the interface of the apparatus according to claim 1, wherein the picture sequence comprises one of the encoded intra-frames of the second video input data stream and at least 30 of the encoded inter-frames of the second video input data stream, wherein the interface of the second encoder is configured to transmit, at first, the encoded intra-frame of the group of pictures and then the at least 30 encoded inter-frames of the group of pictures to the interface of the apparatus according to claim 1, wherein the interface of the second encoder is configured to transmit no other video frame of the second video input data stream between the encoded intra-frame of the picture sequences and between each of the encoded inter-frames of the second video input data stream to the interface of the apparatus according to claim 1,
wherein the interface of the apparatus according to claim 1 is configured to receive the group of pictures, wherein the interface of the apparatus according to claim 1 is configured to receive, at first, the encoded intra-frame of the group of pictures and then the at least 30 encoded inter-frames of the group of pictures, wherein the interface of the apparatus according to claim 1 is configured to receive no other video frame of the second video input data stream between the encoded intra-frame of the picture sequences and between each of the encoded inter-frames of the second video input data stream, and
wherein the video data stream generator of the apparatus according to claim 1 is configured to output the encoded intra-frame of the picture sequence and each of the at least ten encoded inter-frames of the picture sequence as 31 or several successive encoded video frames of the video output data stream.

11. System according to claim 7,
wherein the system further comprises one or several terminal devices,
wherein each of the one or several terminal devices comprises an interface and a decoder,
wherein the interface of each of the one or several terminal devices is configured to receive the video output data stream, and
wherein the decoder of each of the one or several terminal devices is configured to decode the encoded video frames of the video output data stream.

12. Method for generating a video output data stream by switching from a first video input data stream to a second video input data stream, comprising:
receiving encoded video frames of the first video input data stream, wherein each of the encoded video frames of the first video input data stream is either an encoded intra-frame or an encoded inter-frame,
generating the video output data stream, wherein one or several video frames of the first video input data stream are output as one or several encoded video frames of the video output data stream,
receiving a switching command that instructs to switch to the reception of encoded video frames of the second video input data stream, wherein each of the encoded video frames of the second video input data stream is either an encoded intra-frame or an encoded inter-frame,
after receiving the switching command, transmitting a request command requesting the transmission of one of the encoded intra-frames of the second video input data stream,
receiving the encoded video frames of the second video input data stream, and
depending on an arrival of one of the intra-frames of the second video input data stream, outputting this intra-frame and the encoded video frames of the second video input data stream received after arrival of this intra-frame as video frames of the video output data stream,
wherein this intra-frame of the second video data stream is determined in that, after reception of the switching command, each of the arriving encoded video frames of the second video input data stream is checked for the fact whether this encoded video frame is an encoded intra-frame,
wherein this intra-frame is output as a video frame of the video output data stream,
wherein encoded inter-frames of the second video input data stream are received after the switching command has been received and before one of the encoded intra-frames of the second video input data stream has been received after the reception of the switching command,
wherein none of the encoded inter-frames of the second video input data stream received after the switching command has been received and before one of the encoded intra-frames of the second video input data stream has been received after reception of the switching command are output as encoded video frames of the video output data stream, and
wherein each of the encoded inter-frames of the second video input data stream received after the switching command has been received and after at least one of the encoded intra-frames of the second video input data stream has been received after reception of the switching command is output as a video frame of the video output data stream, and
wherein each of the encoded video frames of the first video input data stream received after the switching command has been received and before one of the encoded intra-frames of the second video input data stream has been received after reception of the switching command as encoded video frame of the video output data stream.

13. A non-transitory digital storage medium having a computer program stored thereon to perform the method for generating a video output data stream by switching from a first video input data stream to a second video input data stream, the method comprising:
receiving encoded video frames of the first video input data stream, wherein each of the encoded video frames of the first video input data stream is either an encoded intra-frame or an encoded inter-frame,
generating the video output data stream, wherein one or several video frames of the first video input data stream are output as one or several encoded video frames of the video output data stream,
receiving a switching command that instructs to switch to the reception of encoded video frames of the second video input data stream, wherein each of the encoded video frames of the second video input data stream is either an encoded intra-frame or an encoded inter-frame,
after receiving the switching command, transmitting a request command requesting the transmission of one of the encoded intra-frames of the second video input data stream,
receiving the encoded video frames of the second video input data stream, and
depending on an arrival of one of the intra-frames of the second video input data stream, outputting this intra-frame and the encoded video frames of the second video input data stream received after arrival of this intra-frame as video frames of the video output data stream,
wherein this intra-frame of the second video data stream is determined in that, after reception of the switching command, each of the arriving encoded video frames of the second video input data stream is checked for the fact whether this encoded video frame is an encoded intra-frame,
wherein this intra-frame is output as a video frame of the video output data stream,
wherein encoded inter-frames of the second video input data stream are received after the switching command has been received and before one of the encoded intra-frames of the second video input data stream has been received after the reception of the switching command,
wherein none of the encoded inter-frames of the second video input data stream received after the switching command has been received and before one of the encoded intra-frames of the second video input data stream has been received after reception of the switching command are output as encoded video frames of the video output data stream, and
wherein each of the encoded inter-frames of the second video input data stream received after the switching command has been received and after at least one of the encoded intra-frames of the second video input data stream has been received after reception of the switching command is output as a video frame of the video output data stream, and
wherein each of the encoded video frames of the first video input data stream received after the switching command has been received and before one of the encoded intra-frames of the second video input data stream has been received after reception of the switching command as encoded video frame of the video output data stream,
when said computer program is run by a computer.
